(19) United States
(12) Patent Application Publication
(10) Pub. No.: US 2024/0079627 A1
(43) Pub. Date: Mar. 7, 2024

(54) BANDING STRAPS FOR ASSEMBLING TRACTION BATTERY PACK CELL STACKS

(71) Applicant: FORD GLOBAL TECHNOLOGIES, LLC, Dearborn, MI (US)

(72) Inventors: Michael E. REIBLING, Sterling Heights, MI (US); David WILSON, South Lyon, MI (US); Deanna Marie Winton HOFFMAN, Ann Arbor, MI (US); Alex REVELS, Canton, MI (US)

(21) Appl. No.: 18/306,395

(22) Filed: Apr. 25, 2023

Related U.S. Application Data
(60) Provisional application No. 63/403,445, filed on Sep. 2, 2022.

(51) Int. Cl. H01M 8/248; B60K 1/04; B60L 50/60; H01M 50/204

(52) U.S. Cl. CPC H01M 8/248; B60K 1/04; B60L 50/66; H01M 50/204; B60K 2001/0438

(57) ABSTRACT

Banding straps and associated methods may be used for assembling a cell stack of a traction battery pack. One more banding straps may be arranged about the cell stack for temporarily or permanently applying and maintaining compression across the cell stack. In an exemplary method, a banding strap may be arranged within a compression fixture before positioning a cell stack within the compression fixture and applying a compressive force across a cell stack axis of the cell stack. Free end portions of the banding strap may be connected to maintain the compressive force across the cell stack axis.

### CROSS-REFERENCE TO RELATED APPLICATIONS

This disclosure claims priority to U.S. Provisional Application No. 63/403,445, which was filed on Sep. 2, 2022 and is incorporated herein by reference.

### TECHNICAL FIELD

This disclosure relates generally to traction battery packs, and more particularly to banding straps and associated methods for assembling a cell stack of a traction battery pack.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A method for assembling a cell stack of a traction battery pack according to an exemplary aspect of the present disclosure includes, among other things, arranging a first banding strap in a compression fixture, arranging a cell stack within the compression fixture, applying a compressive force across a cell stack axis of the cell stack, and connecting a first free end portion and a second free end portion of the first banding strap, thereby maintaining the compressive force across the cell stack axis.

In a further non-limiting embodiment of the foregoing method, the cell stack includes at least a first battery cell packet, a second battery cell packet, and a structural thermal barrier between the first battery cell packet and the second battery cell packet.

In a further non-limiting embodiment of either of the foregoing methods, the method includes, after the connecting, removing the cell stack from the compression fixture.

In a further non-limiting embodiment of any of the foregoing methods, the method includes, after the removing, installing a first cross-member beam and a second cross-member beam to the cell stack.

In a further non-limiting embodiment of any of the foregoing methods, the method includes, after the installing, installing a second banding strap about the cell stack.

In a further non-limiting embodiment of any of the foregoing methods, the second banding strap is applied about the cell stack in a direction that is transverse to the first banding strap.

In a further non-limiting embodiment of any of the foregoing methods, the second banding strap is received over the first cross-member beam and the second cross-member beam.

In a further non-limiting embodiment of any of the foregoing methods, the first banding strap extends over top of and beneath the cell stack.

In a further non-limiting embodiment of any of the foregoing methods, applying the compressive force includes moving a first end plate and a second end plate of the compression fixture toward one another to compress the cell stack between a first compression plate and a second compression plate of the cell stack.

In a further non-limiting embodiment of any of the foregoing methods, the first banding strap extends across the first compression plate and the second compression plate.

In a further non-limiting embodiment of any of the foregoing methods, arranging the first banding strap includes hanging the first free end portion of the first banding strap over a first end plate of the compression fixture, and hanging the second free end portion of the first banding strap over a second end plate of the compression fixture.

In a further non-limiting embodiment of any of the foregoing methods, connecting the first free end portion and the second free end portion of the first banding strap includes friction welding the first free end portion and the second free end portion together.

In a further non-limiting embodiment of any of the foregoing methods, the method includes, after the connecting, cutting an excess material from the first banding strap.

In a further non-limiting embodiment of any of the foregoing methods, the first banding strap includes a non-reinforced material that is configured to gradually relax to release compression as the cell stack expands over time.

In a further non-limiting embodiment of any of the foregoing methods, the non-reinforced material includes a thermal bonded polyester.

A traction battery pack according to another exemplary aspect of the present disclosure includes, among other things, a cell stack including a first cross-member beam, a second cross-member beam, a first compression plate, and a second compression plate. A grouping of battery cells are axially supported between the first cross-member beam and the second cross-member beam and longitudinally supported between the first compression plate and the second compression plate. A first banding strap is arranged to exert a compressive force to the grouping of battery cells.

In a further non-limiting embodiment of the foregoing traction battery pack, a second banding strap is arranged about the cell stack in a direction that is transverse to the first banding strap.

In a further non-limiting embodiment of either of the forgoing traction battery packs, the first banding strap includes a non-reinforced material that is configured to gradually relax to release compression as the cell stack expands over time.

In a further non-limiting embodiment of any of the foregoing traction battery packs, the first banding strap extends across the first compression plate, over top of the grouping of battery cells, across the second compression plate, and beneath the grouping of battery cells.

In a further non-limiting embodiment of any of the foregoing traction battery packs, the first banding strap extends across each of the first compression plate, the second compression plate, the first cross-member beam, and the second cross-member beam.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view through section 3-3 of FIG. 2.

FIG. 4 illustrates an exemplary cell stack of the traction battery pack of FIGS. 2 and 3.

FIGS. 5, 6, 7, 8, 9, and 10 schematically illustrate a method of assembling a cell stack of a traction battery pack.

FIG. 11 is a cross-sectional view of a portion of a traction battery pack.

### DETAILED DESCRIPTION

This disclosure details banding straps and associated methods for assembling a cell stack of a traction battery pack. One more banding straps may be arranged about the cell stack for temporarily or permanently applying and maintaining compression across the cell stack. In an exemplary method, a banding strap may be arranged within a compression fixture before positioning a cell stack within the compression fixture and applying a compressive force across a cell stack axis of the cell stack. Free end portions of the banding strap may be connected to maintain the compressive force across the cell stack axis. These and other features are discussed in greater detail in the following paragraphs of this detailed description.

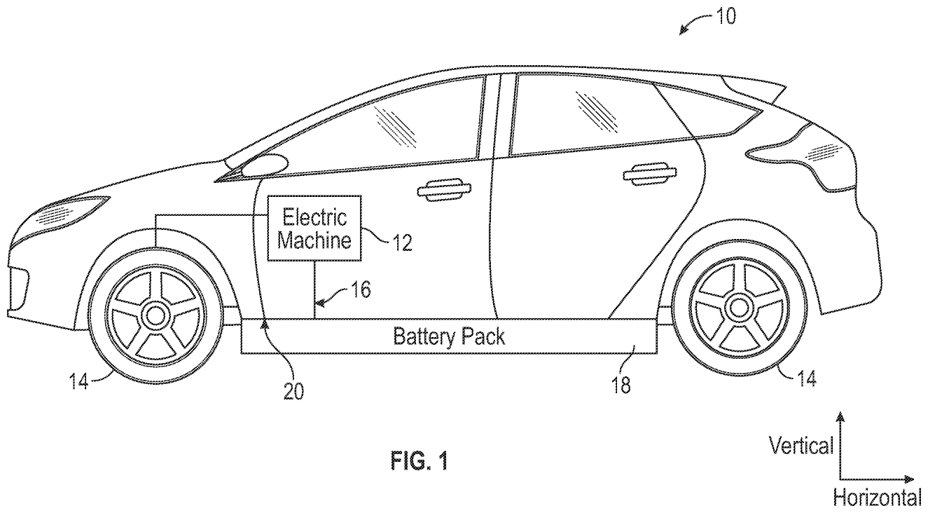

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

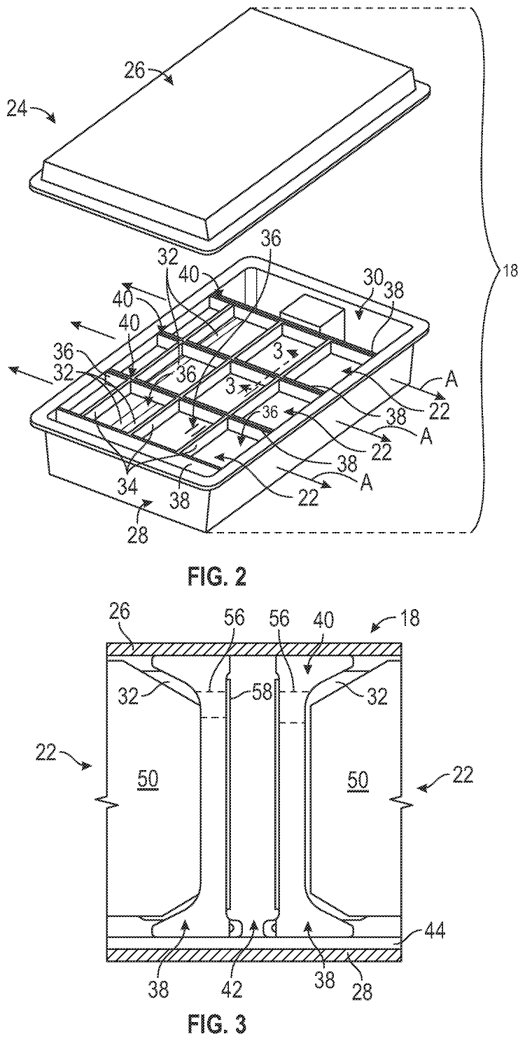

FIGS. 2 and 3 illustrate further details associated with the traction battery pack 18 of the electrified vehicle 10. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked side-by-side relative to one another along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

One or more structural thermal barriers 34 may be arranged along the respective cell stack axis A of each cell stack 22. The structural thermal barriers 34 may compartmentalize each cell stack 22 into two or more groupings or compartments 36 of battery cells 32. Each compartment 36 may hold one or more of the battery cells 32 within one of the cell stacks 22. In an embodiment, the battery cells 32 of each cell stack 22 are held within one of four compartments 36. However, other configurations, including configurations that utilize a greater or fewer number of compartments 36, could be used within the scope of this disclosure.

The battery cells 32 of each cell stack 22 may be arranged between a pair of cross-member beams 38. The cross-member beams 38 may be configured to hold the battery cells 32 and at least partially delineate the cell stacks 22.

The cross-member beams 38 may be adhesively secured to the enclosure cover 26 and to either the enclosure tray 28 or a heat exchanger plate 44 (see FIG. 3) positioned between the enclosure tray 28 and one or more cell stacks 22. The adhesive can seal these interfaces to inhibit battery cell vent byproducts escaping through these areas.

Immediately adjacent-cross member beams 38 may established a cross-member assembly 40 disposed between adjacent cell stacks 22 of the traction battery pack 18. The cross-member assemblies 40 may be configured to transfer a load applied to a side of the electrified vehicle 10, for example. Each cross-member beam 38 of the cross-member assemblies 40 may be a structural beam that can help accommodate tension loads from battery cell 32 expansion and compression loads. The cross-member assemblies 40 are therefore configured to increase the structural integrity of the traction battery pack 18.

The cross-member assembles 40 may also establish a battery pack venting system for communicating battery cell vent byproducts from the traction battery pack 18 during battery thermal events. For example, the cross-member assemblies 40 may establish passageways 42 (best shown in FIG. 3) that can communicate the battery cell vent byproducts from the cell stacks 22 toward a position where the battery cell vent byproducts can be expelled from the traction battery pack 18.

In the exemplary embodiment illustrated in FIG. 3, first and second adjacent cross-member beams 38 may establish a first side and a second side, respectively, of the passageway 42 of the cross-member assembly 40. Further, a vertically upper side of the passageway 42 may be established by the enclosure cover 26, and a vertically lower side of the passageway 42 may be established by a heat exchanger plate 44 positioned against the enclosure tray 28. In another embodiment, the heat exchanger plate 44 may be omitted and the vertically lower side of the passageway 42 may be established by the enclosure tray 28. Vertical and horizontal, for purposes of this disclosure, are with reference to ground and a general orientation of traction battery pack 18 when installed within the electrified vehicle 10 of FIG. 1.

Each cross-member beam 38 of the cell stack 22 may include a plurality of vent openings 56 for communicating battery cell vent byproducts through the beams and into one of the passageways 42. The vent openings 56 thus provide a path for battery cell vent byproducts to move through the cross-member beams 38 and into the passageways 42 as required during a venting event.

When the battery cells 32 of the cell stack 22 are not venting, the vent openings 56 may be covered by a sectioned membrane 58. A pressure differential increase associated with one or more of the battery cells 32 venting can rupture a local section of the sectioned membrane 58, thereby allowing the battery cell vent byproducts to pass through the vent openings 56 for a single battery cell 32 or group of battery cells 32 experiencing a thermal event into the passageway 42. The local sections of the sectioned membrane 58 may locally break away when the single battery cell 32 experiences the thermal event to release the battery cell vent byproducts into the passageway 42. The battery cell vent byproducts may exit on both sides of the cell stack 22.

In an embodiment, the cell stacks 22, the cross-member assemblies 40, and the respective passageways 42 extend longitudinally in a cross-vehicle direction. However, other configurations are further contemplated within the scope of this disclosure.

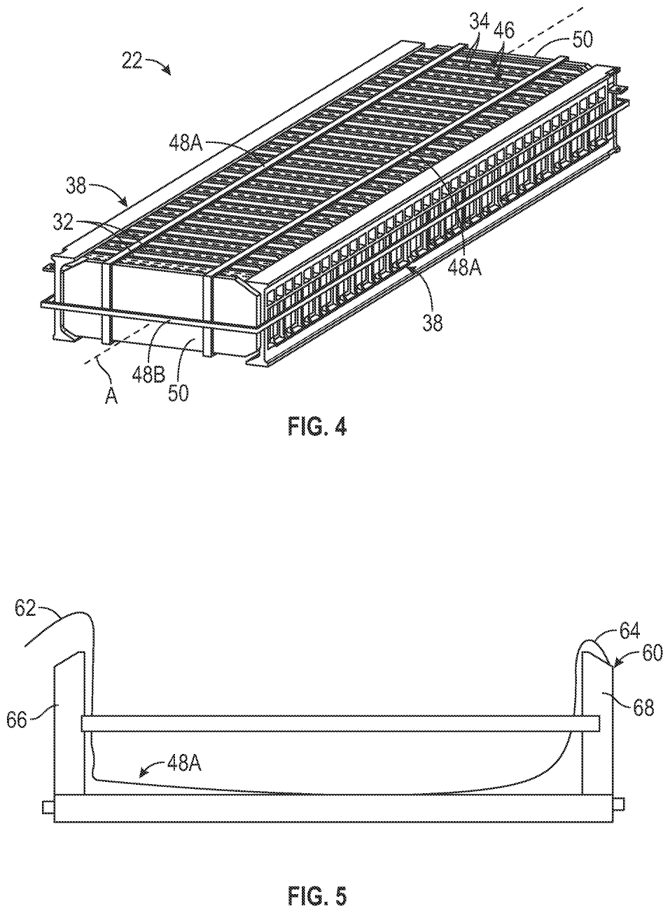

FIG. 4, with continued reference to FIGS. 2 and 3, illustrates an exemplary design of a cell stack 22 of the traction battery pack 18. Additional cell stacks 22 of the traction battery pack 18 could include an identical design to the cell stack 22 shown in FIG. 4, or a similar design as its electrical connections with neighboring cell stacks can vary in order to complete a necessary electrical circuit.

The cell stack 22 may include a plurality of cell packets 46 stacked horizontally between a pair of cross-member beams 38 and longitudinally (e.g., side-by-side along the cell stack axis A) between a pair of compression plates 50. The total number of cell packets 46 provided within the cell stack 22 may vary and is therefore not intended to limit this disclosure.

Each compression plate 50 may be made of a plastic material. The compression plates 50 may be configured to accommodate and maintain compression of the cell stack 22 along the cell stack axis A. The compression plates 50 may be attached to the cross-member beams 38 in any manner.

Each cell packet 46 of the cell stack 22 may include a plurality of battery cells 32. The total number of battery cells 32 provided within each cell packet 46 is not intended to limit this disclosure.

Each cell packet 46 may be separated from a neighboring cell packet 46 by one of the structural thermal barriers 34. The structural thermal barriers 34 may each include a single-piece structure or a multi-layered sandwich structure that is configured to slow or even prevent thermal propagation from cell packet-to-cell packet across the cell stack 22. In an embodiment, the structural thermal barriers 34 may be made of a metallic material, such as stainless steel or aluminum, or a thermoplastic material, for example. In another embodiment, the structural thermal barriers 34 include an insulating material(s), such as aerogel materials or foam materials. However, other material or combinations of materials could with utilized to provide the structural thermal barriers 34 with insulative properties within the scope of this disclosure.

Banding straps may be used to temporarily or permanently apply and maintain compression across the cell stack 22. For example, the cell stack 22 may include one or more banding straps 48A and/or one or more banding straps 48B. The total number of each banding strap 48A, 48B provided as part of the cell stack 22 is not intended to limit this disclosure.

The banding strap(s) 48A may be positioned to extend vertically across the compression plates 50 and directly over top of and beneath the battery cells 32, and the banding strap(s) 48B may be positioned to extend laterally across the compression plates 50 and around the lateral sides of the battery cells 32 (e.g., directly over the cross-member beams 38 in a direction parallel to the cell stack axis A). In some implementations, only the banding straps 48A are provided about the cell stack 22. In other implementations, only the banding straps 48B are provided about the cell stack.

The compression plates 50 are arranged to protect the battery cells 32 from forces that could be imparted by the banding straps 48A and/or the banding straps 48B. For example, the compression plates 50 may substantially prevent the banding straps 48A and/or 48B from directly impinging on the battery cells 32 located at the terminal ends of the cell stack 22.

The banding straps 48A, 48B may be made of any suitable polymeric or metallic material. In an embodiment, the banding straps 48A, 48B are made of polypropylene. In another embodiment, the banding straps 48A, 48B are made of a non-reinforced material that is designed to gradually relax to release compression as the battery cells 32 expand over time. An exemplary non-reinforced material may include a thermal bonded polyester. However, other materials may also be suitable within the scope of this disclosure.

FIGS. 5, 6, 7, 8, 9, and 10, with continued reference to FIGS. 1-4, schematically illustrate a method for assembling one of the cell stacks 22 of the traction battery pack 18. The method may include a greater or fewer number of steps than recited below, and the exact order of the steps is not intended to limit this disclosure.

Referring first to FIG. 5, one or more of the banding straps 48A may be positioned within a compression fixture 60. Each banding strap 48A may be arranged such that a first free end portion 62 of the banding strap 48A hangs over a first end plate 66 of the compression fixture 60 and a second free end portion 64 of the banding strap 48A hangs over a second end plate 68 of the compression fixture 60.

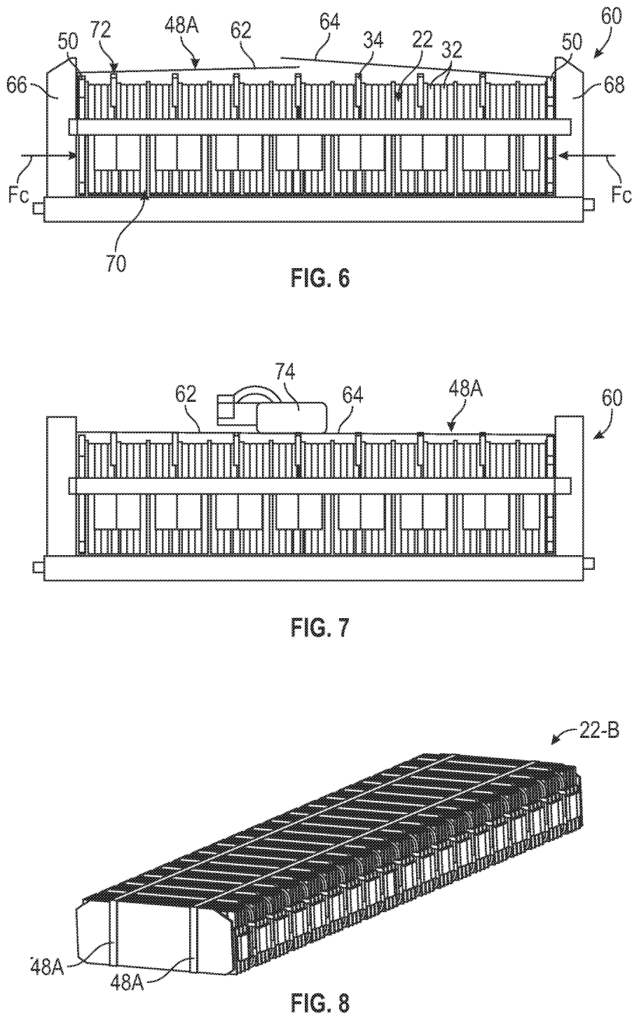

Referring to FIG. 6, the cell stack 22 may next be arranged within the compression fixture 60. Notably, the cell stack 22 is arranged within the compression fixture 60 without the cross-member beams 38, which are added during a subsequent step. The compression fixture 60 may provide a reference point for arranging the battery cells 32 and the structural thermal barriers 34 along the cell stack axis A. Once the cell stack 22 is positioned within the compression fixture 60, the banding strap 48A may extend beneath a bottom surface 70 of the cell stack 22 and vertically along the compression plates 50, and the first and second free end portions 62, 64 of the banding strap 48A may extend over top of a top surface 72 of the cell stack 22.

The cell stack 22 may next be compressed along the cell stack axis A within the compression fixture 60. The first end plate 66 and the second end plate 68 of the compression fixture 60 may be moved toward one another to exert a compressive force Fc along the cell stack axis A to the opposed ends of the cell stack 22. The compressive forces Fc applied by the first and second end plates 66, 68 essentially squeeze the battery cells 32 between the compression plates 50, thereby compressing the cell stack 22 and the individual battery cells 32 to a desired cell stack length.

In an embodiment, the compressive force Fc exerted on the battery cells 32 by the compression fixture 60 is about 3 kilonewtons. However, the actual compression force applied can vary depending on the battery cell type, among other factors. In this disclosure, the term “about” means that the expressed quantities or ranges need not be exact but may be approximated and/or larger or smaller, reflecting acceptable tolerances, conversion factors, measurement error, etc.

The first end plate 66 and the second end plate 68 of the compression fixture 60 could be driven by a pneumatic actuator to compress the battery cells 32 along the cell stack axis A. However, other types of actuators, such as a DC electrical or a mechanical screw actuator, could alternatively be employed for achieving the compression.

Next, as shown in FIG. 7, a banding machine 74 may be connected to the first and second free end portions 62, 64 of the banding strap 48A while the cell stack 22 is maintained under compression within the compression fixture 60. The banding machine 74 may be operated to tighten the banding strap 48A, connect the free end portions 62, 64 together (e.g., by friction welding), and then cut excess material from the banding strap 48A.

Referring to FIG. 8, the cell stack 22 may next be removed from the compression fixture 60 as a banded cell stack 22-B. The banded cell stack 22-B includes the majority of the cell stack subcomponents but omits the cross-member beams 38.

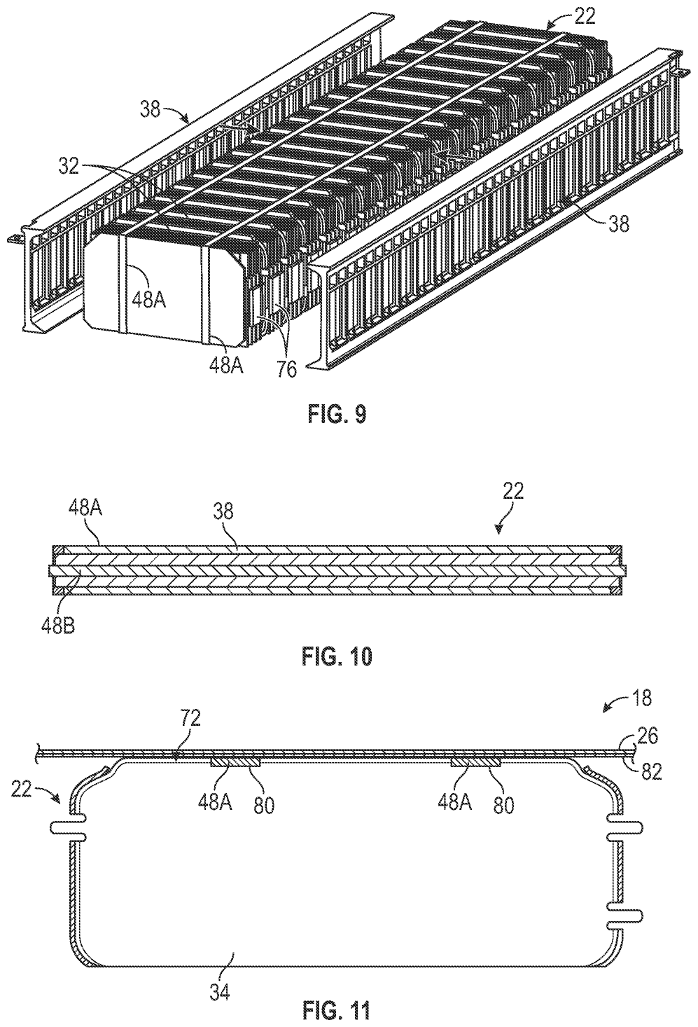

Next, as shown in FIG. 9, the cross-member beams 38 may be installed onto the banded cell stack 22-B. The cross-member beams 38 support and hold the battery cells 32 of the cell stack 22. Cell tab terminals 76 of the battery cells 32 of the cell stack 22 may then be welded together after the cross-member beams are installed.

Finally, as shown in FIG. 10, one or more of the banding straps 48B may be installed for further supporting the cell stack 22. The banding strap 48B may be applied about the cell stack 22 in a direction that is transverse to the banding strap 48A. In an embodiment, the banding strap 48B is positioned to extend about the compression plates 50 and the cross-member beams 38 of the cell stack 22 when installed.

In an exemplary method, the method steps schematically illustrated in FIGS. 5-10 can be performed multiple times to provide the desired number of cell stacks 22 for the traction battery pack 18. The banding straps 48A, 48B may either be removed or maintained after positioning the respective cell stack 22 within the enclosure assembly 24.

Referring now to FIG. 11 (with continued reference to FIGS. 1-10), the structural thermal barriers 34 of the cell stack 22 may include notches 80 for receiving the banding straps 48A. The banding straps 48A may therefore be received flush relative to the top surface 72 of the cell stack 22, thereby better accommodating the banding straps 48A without necessitating their removal from the cell stack 22.

The cell stack 22 may be secured directly to the enclosure cover 26 (or some other upper enclosure structure) by an adhesive 82. The adhesive 82 may be an epoxy based adhesive or a urethane based adhesive, for example. The adhesive 82 may increase the stiffness across the traction battery pack 18.

The banding straps of this disclosure are capable of temporarily or permanently supporting various subcomponents of a battery cell stack. The banding straps may or may not need removed after assembly. In some implementations, the banding straps may be configured to gradually release compression over time and in response to battery cell expansion forces.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method for assembling a cell stack of a traction battery pack, comprising:
arranging a first banding strap in a compression fixture;
arranging a cell stack within the compression fixture;
applying a compressive force across a cell stack axis of the cell stack; and
connecting a first free end portion and a second free end portion of the first banding strap, thereby maintaining the compressive force across the cell stack axis.

2. The method as recited in claim 1, wherein the cell stack includes at least a first battery cell packet, a second battery cell packet, and a structural thermal barrier between the first battery cell packet and the second battery cell packet.

3. The method as recited in claim 1, comprising, after the connecting, removing the cell stack from the compression fixture.

4. The method as recited in claim 3, comprising, after the removing, installing a first cross-member beam and a second cross-member beam to the cell stack.

5. The method as recited in claim 4, comprising, after the installing, installing a second banding strap about the cell stack.

6. The method as recited in claim 5, wherein the second banding strap is applied about the cell stack in a direction that is transverse to the first banding strap.

7. The method as recited in claim 6, wherein the second banding strap is received over the first cross-member beam and the second cross-member beam.

8. The method as recited in claim 1, wherein the first banding strap extends over top of and beneath the cell stack.

9. The method as recited in claim 1, wherein applying the compressive force includes:
moving a first end plate and a second end plate of the compression fixture toward one another to compress the cell stack between a first compression plate and a second compression plate of the cell stack.

10. The method as recited in claim 9, wherein the first banding strap extends across the first compression plate and the second compression plate.

11. The method as recited in claim 1, wherein arranging the first banding strap includes:
hanging the first free end portion of the first banding strap over a first end plate of the compression fixture; and
hanging the second free end portion of the first banding strap over a second end plate of the compression fixture.

12. The method as recited in claim 1, wherein connecting the first free end portion and the second free end portion of the first banding strap includes:
friction welding the first free end portion and the second free end portion together.

13. The method as recited in claim 1, comprising, after the connecting, cutting an excess material from the first banding strap.

14. The method as recited in claim 1, wherein the first banding strap is comprised of a non-reinforced material that is configured to gradually relax to release compression as the cell stack expands over time.

15. The method as recited in claim 14, wherein the non-reinforced material includes a thermal bonded polyester.

16. A traction battery pack, comprising:
a cell stack including:
a first cross-member beam;
a second cross-member beam;
a first compression plate;
a second compression plate;
a grouping of battery cells axially supported between the first cross-member beam and the second cross-member beam and longitudinally supported between the first compression plate and the second compression plate; and
a first banding strap arranged to exert a compressive force to the grouping of battery cells.

17. The traction battery pack as recited in claim 16, comprising a second banding strap arranged about the cell stack in a direction that is transverse to the first banding strap.

18. The traction battery pack as recited in claim 16, wherein the first banding strap is comprised of a non-reinforced material that is configured to gradually relax to release compression as the cell stack expands over time.

19. The traction battery pack as recited in claim 16, wherein the first banding strap extends across the first compression plate, over top of the grouping of battery cells, across the second compression plate, and beneath the grouping of battery cells.

20. The traction battery pack as recited in claim 16, wherein the first banding strap extends across each of the first compression plate, the second compression plate, the first cross-member beam, and the second cross-member beam.
